(19) United States
(12) Patent Application Publication
(10) Pub. No.: US 2015/0089946 A1
(43) Pub. Date: Apr. 2, 2015

(54) THERMAL ENERGY GENERATOR

(71) Applicant: Nestor Dofredo, Seattle, WA (US)

(72) Inventor: Nestor Dofredo, Seattle, WA (US)

(21) Appl. No.: 14/044,519

(22) Filed: Oct. 2, 2013

(51) Int. Cl. F03G 6/04

(52) U.S. Cl. CPC F03G 6/045
USPC 60/641.12

(57) ABSTRACT

A thermal energy generator of a size and configuration such that it captures and accelerates wind and thermal flow to drive a variable pitch internal propeller and an interconnected generator.

### TECHNICAL FIELD

The current invention relates to generation of energy, and more particularly to an inverted conical shell which captures wind and thermal energy, accelerating them and channeling them upwardly to a variable pitch internal propeller which drives a generator.

### BACKGROUND OF THE INVENTION

In an ongoing effort to reduce air pollution and perhaps reduce global warming, it is the goal of many people to reduce the utilization of fossil fuels to generate electricity. Thus the growth of the wind turbine industry, as well as the solar panel industry. Both of these approaches have negative side effects, which will not be discussed in detail.

In an effort to provide electric energy and overcome some of the hazards with the prior art, the present invention has devised an apparatus for capturing heat as well as wind power and then harnessing the two, such that they drive a variable pitch propeller and generate electricity.

### Prior Art

U.S. Pat. No. 4,118,636 to Christian discloses a conical structure for collecting and heating air that then flows through a unitary rotor and turbine.

U.S. Pat. No. 4,224,528 to Argo discloses an enclosed transparent tower providing a confined space for solar heating of the captured air which then flows through an upright wind turbine mounted on the tower top to drive an electric generator.

US Publication No. 2007/0252391 to Chen discloses a power generator mounted to the upper surface of a household chimney.

U.S. Pat. No. 7,511,387 to Fakhrai discloses the utilization of a natural element such as a mountain through which one or more conduits are placed or generated, causing air to flow from the lower elevation to the upper elevation and driving a generator mounted within the conduit.

U.S. Pat. No. 7,821,151 to Le et al discloses a solar chimney utilizing solar energy to heat the air which flows upwardly through the chimney driving an air turbine which in turn drives a generator.

PCT Publication No. WO 2011/025914, discloses a power generator using buoyancy-induced vortices.

US Publication No. 2011/0074164 to Kobayashi discloses a solar thermal power generation unit capitalizing both thermal and wind power to drive a generator.

U.S. Pat. No. 7,956,487 to Havakimian discloses the conversion of heat energy released by compostable matter into electricity utilizing an updraft tower.

U.S. Pat. No. 8,058,742 to Erdman et al discloses a thermal management system for a standard wind turbine.

U.S. Pat. No. 8,115,322 to Glynn discloses a solar-initiated wind power generation system including a solar canopy above-ground and at least one wind-driven power turbine and generator connected to a support member for the canopy.

### SUMMARY OF THE INVENTION

With the above-noted prior art in mind, it is the goal of the present invention to provide a transparent frustoconical shell and utilizing structural members within the shell to capture and deflect wind energy upwardly while simultaneously heating the air within the shell, compressing and directing the heated air through a variable pitch propeller to drive a generator, creating electricity

### BRIEF DESCRIPTION OF THE DRAWINGS

FIG. 1 is a side elevational view of the inventive thermal energy generator.

FIG. 2 is a side elevational view of the inventive generator showing the wind flow and a more detailed view of the wind deflector system.

FIG. 3 is an alternative configuration of the inventive thermal generator

### BEST MODE FOR CARRYING OUT THE INVENTION

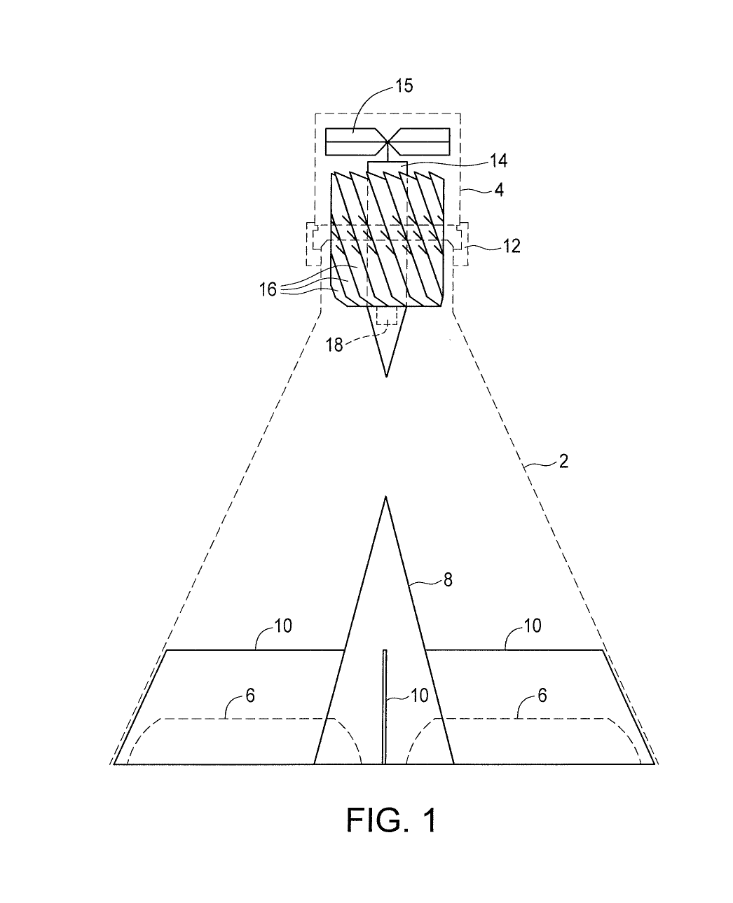

As seen in FIG. 1, the thermal energy generator includes an inverted transparent or translucent frustoconical shell which terminates at its upper end in a cylindrical extension 4. Spaced along the lower portion of the shell 2 are openings 6 which allow the inflow of wind and heated air. Centrally located in the interior of the shell 2 is a conical central element 8 having a plurality of radially extending fins 10 which extend from the cone 8 to the shell 2 directing the airflow upwardly, as explained hereinafter.

The exterior of the cylindrical portion 4 likewise includes openings to permit the inward airflow and is encircled by a cylindrical band including openings allowing the inward flow. Centrally mounted in the cylindrical portion 4 is a cylindrical element 14 having a pointed end downwardly, and mounted thereto are a series of baffles 16 diverting the incoming air from the outside through openings 12 and upwardly through the cone shell to drive a variable speed propeller 15. Optionally mounted within the enclosure 14 is an electric generator 18.

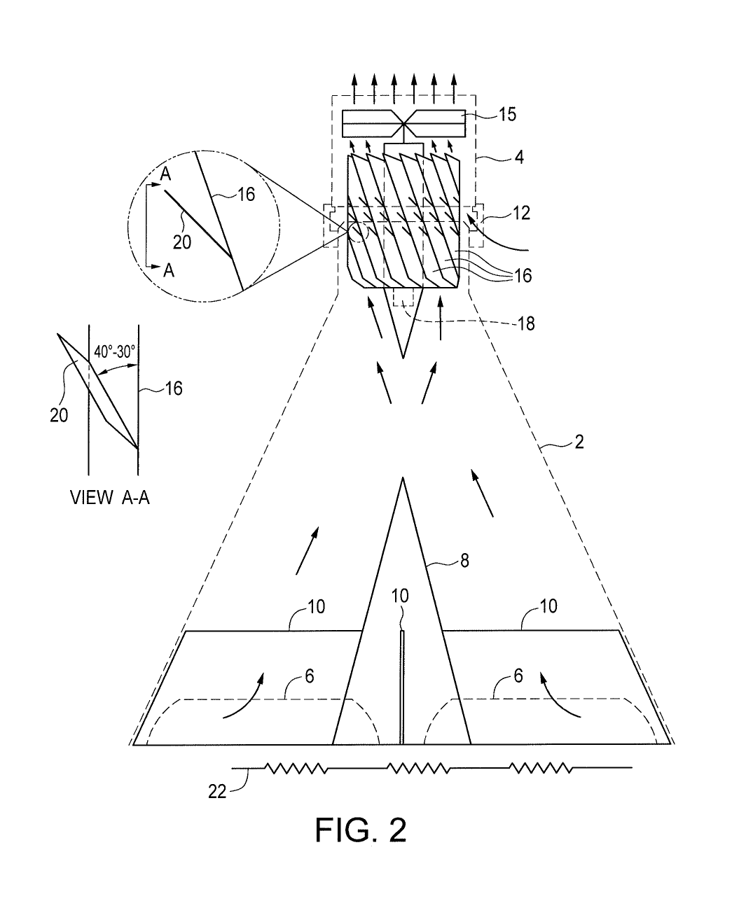

Reference is now had to FIG. 2, wherein the identical elements have identical numerical designations and further include the arrows depicting the airflow upwardly through the cone, wherein the wind and heated air are forced upwardly inside the cone and thus compressed and the flow is increased, and further, the airflow through the upper cylinder is added and is diverted by the fins 16 and, as best seen in this view, the baffles 20. Further to be seen in this view is an auxiliary heater element 22 to supplement the heat and wind airflow under adverse conditions.

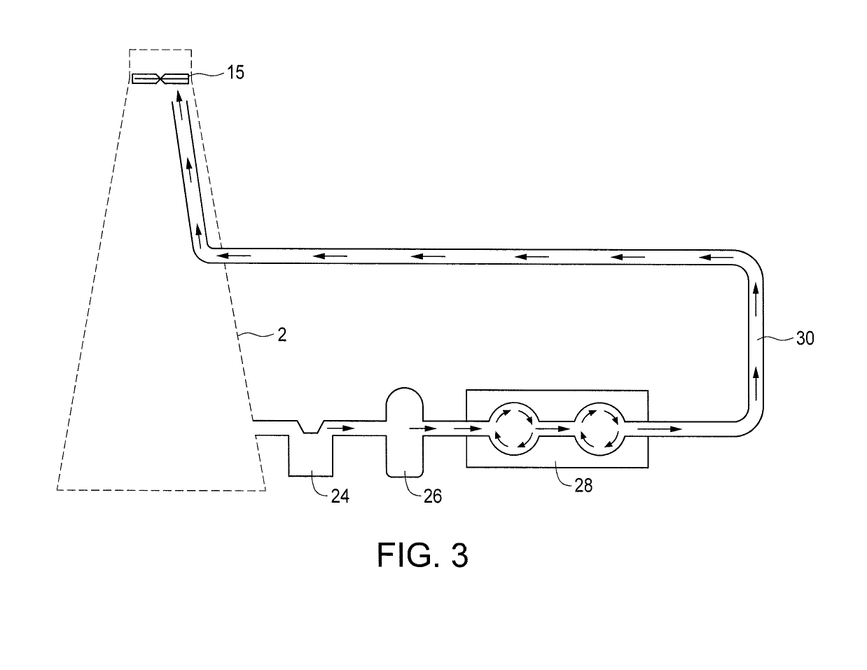

As seen in FIG. 3, an auxiliary source of air is incorporated to stabilize and improve the efficiency of the generator. The auxiliary source is shown inside the cone but could be located outside the cone.

A conduit 22 draws air passing through the compressor 24 and is temporarily stored in a tank 26 to be used as needed. Air under pressure is then passed through single or multiple generators 28 generating electricity. The air exiting the generators 28 is channeled through conduit 30 to exit upstream of and powering variable pitch fan 15.

It is to be understood that the basic generator can operate as a unit or in combination with the auxiliary unit shown in FIG. 3. The basic generator unit could be used to power compressor 24, or the compressor could be mechanically connected to fan 15.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A thermal energy generator, comprising:
a frustoconical shell terminating in a cylindrical vertical extension at the upper end thereof, said shell including openings in the sidewall at the bottom thereof and the cylindrical extensions having openings in the sidewall such that air flows inwardly at the top and bottom of the generator;
a plurality of vertical wind deflectors at the bottom of the generator;
a plurality of fins within the cylindrical extension placed at a angle to the axis of the cylindrical extension direct to the air flow; and
an adjustable pitch propeller at the upper end of the cylindrical extension such that thermal and wind flow pass through the propeller causing rotation thereof and driving a generator.

2. A thermal energy generator as in claim 1, wherein the fins include adjustable baffles adjacent the openings in the cylindrical extension.

3. A thermal generator as in claim 1, and further including an inverted cone at the bottom of the shell to assist in deflecting air upwardly to the propeller.

4. A thermal energy generator as in claim 1, wherein the generator is mounted within the housing supporting the fins.

5. A thermal energy generator as in claim 1, wherein the generator is within the shell.
